(19) United States
(12) Patent Application Publication
(10) Pub. No.: US 2024/0272654 A1
(43) Pub. Date: Aug. 15, 2024

(54) METHOD FOR CONTROLLING A CONVEYED FLUID MASS FLOW BY MEANS OF DIFFERENTIAL PRESSURE MEASUREMENT, AND SYSTEM THROUGH WHICH FLUID FLOWS

(71) Applicant: BMA BRAUNSCHWEIGISCHE MASCHINENBAUANSTALT AG, Braunschweig (DE)

(72) Inventors: Gerald CASPERS, Meine (DE); Hartmut HAFEMANN, Lehrte (DE)

(21) Appl. No.: 18/569,047

(22) PCT Filed: Jun. 8, 2022
(86) PCT No.: PCT/EP2022/065525

§ 371 Date: Dec. 11, 2023

(30) Foreign Application Priority Data
Jun. 15, 2021 (DE) 10 2021 115 471.5

(51) Int. Cl. G05D 7/06

(52) U.S. Cl. CPC G05D 7/0617

(57) ABSTRACT

The invention relates to a method for controlling a conveyed mass flow of fluid or air in a system (1) through which fluid or air flows, comprising: an inlet (2); at least one fan (3) connected downstream of the inlet (2) in the flow direction and having a drive (4); an outlet (5) for conveyed fluid or conveyed air from the fan (3); a pressure loss portion (6) between the fan (3) and the outlet (5); and at least one sensor (7, 8), which is coupled to at least one calculation module (9a, 9b) and to at least one control device (22a, 22b), by means of which the drive (4) of the fan (3) is controlled on the basis of sensor values. A first pressure sensor (7) is provided upstream of the fan (3) in the flow direction and a second pressure sensor (8) is provided downstream of the pressure loss portion (6) in the flow direction, and the speed of the fan (3) is controlled on the basis of the measured pressure difference between the two pressure sensors (7, 8).

The invention relates to a method for controlling a conveyed mass flow of fluid in a system through which fluid flows, having: an inlet; at least one fan which in the flow direction is disposed downstream of the inlet and has a drive; an outlet for the fluid conveyed by the fan; a pressure loss portion between the fan and the outlet; and at least one sensor which is coupled to a calculation module and at least one control device by way of which the drive of the fan is controlled based on sensor values. The invention likewise relates to a system through which fluid flows, for carrying out such a method, having an inlet; at least one fan which in the flow direction is disposed downstream of the inlet and has a drive; an outlet for the fluid conveyed by the fan; a pressure loss portion between the fan and the outlet; and at least one sensor which is coupled to a calculation module and at least one control device by way of which the drive of the fan is controlled based on sensor values. A fluid is understood to mean in particular gaseous media, in particular air, vapor and other gases, gas mixtures, or gases with added small liquid and/or solid particles.

In many processes and in many systems it is necessary to convey air or gaseous fluids by fans and to use the latter. The conveyed air serves, for example, for cooling, heating, drying, transporting material, mixing, or for other purposes of material preparation or processing. An important factor in these processing and handling procedures is the fluid or air mass, or the volumetric flow of fluid or air, used herein. For example, the volumetric flow of fluid or air supplied for drying a product is a substantial variable, because the absorption or dissipation of moisture can be adjusted by way of said volumetric flow. Changing the volumetric flow of fluid or air, or the fluid or air mass, takes place by varying the rotating speed of the fan. The calculated volumetric flow of fluid or air here is determined by way of a characteristic curve of the fan, whereby the characteristic curve of the fan is either measured or provided by the manufacturer of the fan. The correlation between generated pressure and the volumetric flow for a defined rotating speed of the fan is illustrated in the characteristic curve of the fan. Different characteristic curves are derived for different rotating speeds of the fan, such that a map which covers a wider range of potential volumetric flows can be generated by varying the rotating speed. A consistent volumetric flow, or a precise adjustment of the volumetric flow, is advantageous with a view to achieving the desired result and an economical process.

Within the system in which the fan and the compressed air or the fluid are used, measuring of the fluid or air mass flow, or of the volumetric flow of fluid or air, takes place by way of a measuring probe. A method for controlling the volumetric flow of a fan is known from EP 3 287 641 A1, in which an impeller driven by the volumetric flow of the fan is disposed in an exhaust portion of the fan. The rotating speed of the impeller is detected and serves as a reference value of the volumetric flow of the fan. A drive motor parameter, or the fan wheel rotating speed, is detected as the fan parameter, and a correction function of the volumetric flow is established as a function of the fan parameter. A measurement of the volumetric flow by means of an impeller anemometer is thus required for controlling the volumetric flow.

CN 10 505 224 B relates to a control of the drying system having a fan, wherein a control unit has a volumetric flow measurement apparatus, a pressure sensor, an actuator and a data processing device. The volumetric flow measurement apparatus and the pressure sensor are used to detect the volumetric flow and the pressure at the air inlet of the dryer. The data detected are transmitted to the data processing device. The actuator is actuated by a control signal as a function of the sensor data, so as to change the size of a throughflow opening.

U.S. Pat. No. 10,184,680 B2 relates to a method for controlling a motor of a fan, a setpoint volume of the air to be conveyed being initially entered in a control unit. The motor is operated at a preset torque until a state of equilibrium has been achieved. The air volume generated by the motor at the adjusted torque is determined, an adjustment coefficient is calculated, and the torque is subsequently adapted in order to achieve the desired air mass flow.

The methods known from the prior art are either complicated, or require a control flap or a volumetric flow measurement apparatus. Volumetric flow measurement apparatuses in particular require parameters in terms of construction and process technology which can be implemented only with complexity. In order to obtain a stable measuring signal from the volumetric flow measurement apparatus, a comparatively high minimum fluid velocity of approximately 20 meters per second has to be achieved. Moreover, entry and exit sections for the fluid or air management are necessary, the length of said sections being dependent on the pipeline routing and on the diameter of the flow duct in which the volumetric flow measurement apparatus is situated. For example, in the case of a duct diameter of 500 mm, this results in a required length of the measuring section of 8 m in a straight duct. If these parameters are not adhered to, this leads to compromises in terms of the accuracy of the measurement. If precise measurement values are desired, this means that the complexity in terms of construction increases, and the costs increase too.

It is an object of the present invention to provide a method for controlling a conveyed fluid or air mass flow in a system through which fluid or air flows, and a system through which fluid or air flows for carrying out the method, by way of which simple fluid or air mass control can be achieved in a cost-effective and retrofittable manner.

According to the invention, this is achieved by a method having the features of the main claim, and by a system having the features of the coordinate claim. Advantageous design embodiments and refinements of the invention are disclosed in the dependent claims, the description and the figures.

The method for controlling a conveyed mass flow of fluid or air and a system through which fluid or air flows having an inlet, at least one fan which in the flow direction is disposed downstream of the inlet and has a drive, an outlet for the fluid or air conveyed by the fan, a pressure loss portion between the fan and the outlet, and at least one sensor which is coupled to a calculation module and at least one control device by way of which the drive of the fan is controlled based on sensor values, provides that a first pressure sensor in the flow direction is disposed ahead of the fan, and a second pressure sensor in the flow direction is disposed after the pressure loss portion, and the fan in terms of rotating speed is controlled based on the measured pressure difference between the two pressure sensors. It is achieved by the method that it can be easily determined how the drive of the respective fan has to be controlled, thus whether a higher or lower rotating speed or output has to be made available in order to provide the respective required fluid or air mass, by the simple measurement of the pressure at two locations along the flow duct. No flow sensors are required or used for determining the control variable, this resulting in a cost saving and a reduction of the required installation space as a result of the required fluid or air duct length being reduced in comparison to conventional methods. Overall, the space requirement is noticeably minimized by dispensing with flow sensors. Moreover, there is no maintenance effort for the pressure sensors, which is inevitable in flow sensors due to the unavoidable contamination. Two pressure sensors can be readily inserted and retrofitted at the required locations and positions within the system, such that improved control of the fluid or air mass flow can be achieved in a simple manner and without extensive constructive modifications as a result of the installation of sensors.

A refinement provides that the fluid or the air is prepared by at least one fluid or air preparation apparatus ahead of the first pressure sensor, for example by a cooling unit, a filter and/or a drying device. This fluid or air preparation apparatus, or these fluid or air preparation apparatuses, provide a fluid or air quality which is required for the further utilization of the fluid or the air in the system. The disposal of these air preparation apparatuses, or at least one preparation apparatus, ahead of the first pressure sensor prevents that these devices or apparatuses influence the determination of the first measurement value and thus a substantial parameter for determining the control variable.

A refinement provides that the fluid or the air is prepared by at least one preparation device after the fan, and is adjusted in particular with a view to moisture, temperature and/or contamination so as to guarantee the property of the fluid conveyed by the fan, or of the air conveyed by the fan, as required by the respective process. The temperature control can take place, for example, by heating and/or adding cold air or a fluid of a different temperature from a parallel fan line. For this purpose, it is provided that differently prepared air or differently prepared fluid from a plurality of fans is supplied to the pressure loss portion. The first pressure sensor here is disposed ahead of both, or the multiplicity of, the fans, so as to determine the first pressure measurement value.

In a refinement of the method, the air or the fluid after the fan or the fans is directed through a material preparation device within the pressure loss portion, said material preparation device being used, for example, for drying, cooling, singularizing or otherwise preparing a material. The material preparation device can be, for example, a drum dryer, a drum cooling device, and/or a separator, and is part of the pressure loss portion or forms the latter. The material used is in particular moist bulk material of the food-processing, biomass-processing or chemical-processing industry.

In order to adapt the fluid or air mass in the context of the control, if the pressure difference measured and determined between the two sensors deviates from the specified value, a refinement provides that the required rotating speed of the drive is determined from a curve family which is stored in the calculation module. For each fan there is either a measured characteristic curve or a characteristic curve determined by the manufacturer, which indicates the correlation between fluid or air throughput and generated pressure for a specific rotating speed at the respective fan. When the pressure difference is measured by way of the fan, and the rotating speed of the fan is known, the fluid or air throughput, and thus the fluid or air mass flow, can be determined by means of the respective characteristic curve. If the rotating speed of the fan is changed, this results in a new characteristic curve. These new characteristic curves are either provided by the manufacturer, or are measured, or modified by way of calculation methods, such that this results in a curve family which indicates the pressure loss of the systems through which air flows at different rotating speeds for a specific fluid or air throughput. In order for this curve family to be utilized for controlling, the correlation between pressure difference and fluid or air throughput at the respective rotating speed is used.

The system through which fluid or air flows, for carrying out the method as described above, having an inlet, at least one fan which in the flow direction is disposed downstream of the inlet and has a drive, an outlet for air or fluid conveyed by the fan, a pressure loss portion between the fan and the outlet, and at least one sensor which is coupled to a calculation module and at least one control device by way of which the drive of the fan is controlled based on sensor values, provides that a first pressure sensor in the flow direction is disposed ahead of the fan, and a second pressure sensor in the flow direction is disposed after the pressure loss portion, wherein both pressure sensors are coupled to the control device which controls the drive by changing the fan rotating speed based on the pressure difference calculated from the measured pressure sensor values. The disposal of the two sensors, one ahead of the fan and one after the pressure loss portion, enables a low-maintenance, robust and retrofittable construction by way of which a precise control of the fluid or air mass in systems through which a flow passes is possible. The system can also be used in the case of air containing dust, or fluid containing dust, because the pressure measurement can be carried out independently of the fluid or air quality. In order to retrofit pressure sensors which are not present, it is only necessary to incorporate bores in a flow duct and to mount a respective corresponding sensor; entry sections and exit sections for harmonizing the flow of the fluid or the air are not necessary. Should pressure sensors already be present in a system, but to date be used for other tasks, such as controlling a negative pressure in a drying device or for monitoring the load of a fresh air filter, no additional sensors are required. The existing sensors can be utilized in the context of the invention.

At least one fluid or air preparation apparatus for improving or adjusting the required fluid or air quality can be disposed ahead of the first pressure sensor. At least one fluid or air preparation device for the more precise adjustment and adaption of the process medium can be disposed after the fan, in particular so as to be able to adjust different temperatures or temperature variations in the course of a material preparation process.

In the flow direction after the first pressure sensor, a branch line for easier mixing of different fluid or air qualities can lead to a second fan or a further fan which likewise conveys fluid or air into the pressure loss portion. In this instance, both fans are considered and taken into account in the context of controlling. The branch is preferably established ahead of the first fan.

In a refinement, a material preparation device, in particular a dryer, which has a material supply port is disposed in the pressure loss portion. The material to be prepared is supplied to the device by way of the material supply port. The material can also be retrieved again by way of the supply port if no separate material outlet is provided. In the case of one inlet and one outlet, a continuous material preparation can also be performed.

In a refinement, the second pressure sensor is positioned directly at the end of the pressure loss portion, for example at the end of the material preparation device, as a result of which the accuracy of the determination of the pressure difference is increased because the measurement is not influenced by any further pressure losses within the pipeline of the system.

An exemplary embodiment of the invention will be explained in more detail hereunder with reference to the figures, in which:

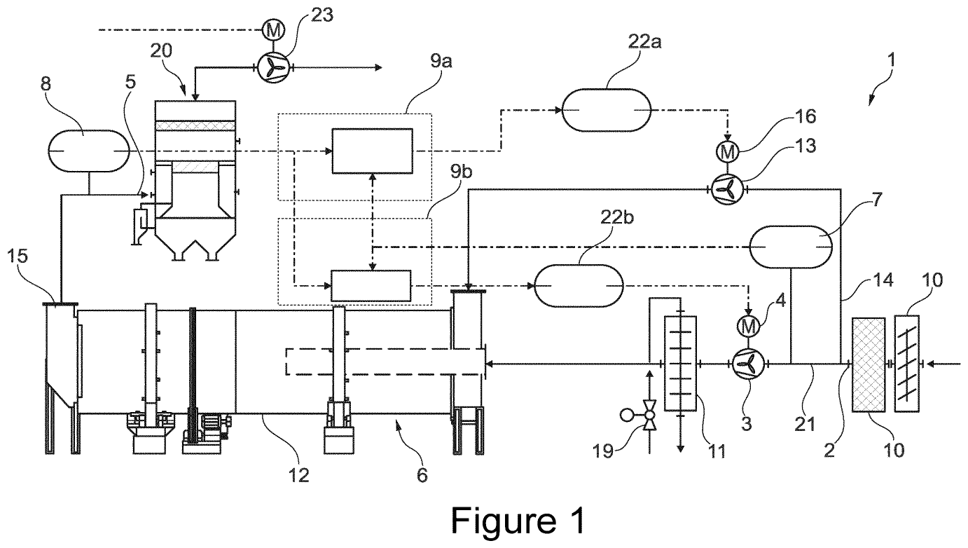

FIG. 1—shows a schematic illustration of an air mass control on a drum dryer; and

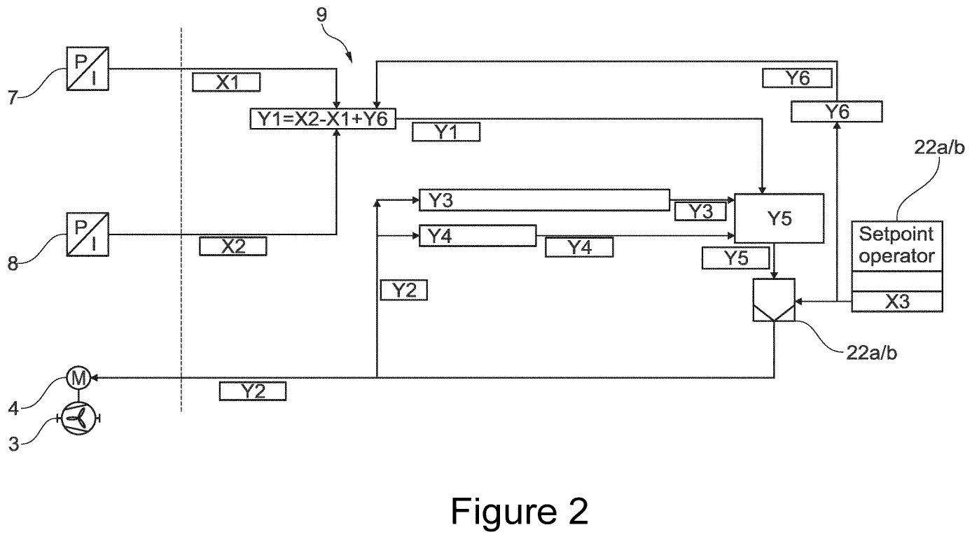

FIG. 2—shows a signal flow chart for the control of a fan of FIG. 1.

A system 1 for preparing and/or for conditioning materials from an upstream processing stage is illustrated in FIG. 1, for example for drying or cooling chemical products, moist bulk materials or other products of the processing industry. The system 1 has an inlet 2 for a fluid to be introduced, for example for fresh air or any other gaseous medium. When reference hereunder is made to air, the explanations fundamentally refer also to all gaseous fluids, in particular also to vapor.

Two air preparation apparatuses 10, which may also be disposed outside a building in which the system 1 is operated, are disposed upstream of the inlet 2 in the flow direction. The air preparation apparatuses 10 are, for example, a weather protection, a filter, flow-influencing components such as louvres, dehumidifiers, heat exchangers, frost-protection devices, or diverting devices. The fluid is suctioned through the air preparation apparatuses 10 into a main line 21 by a fan 3 driven by an electric motor 4. The fan 3 forces the fluid through the main line 21 to an air preparation device 11 which is downstream in the flow direction. For example, the fluid can be adjusted in particular in terms of its temperature using this air preparation device 11, in particular be heated or cooled by way of a heat exchanger. The heat exchanger, as the air preparation device 11, is passed through by a flow of a heat transfer medium, the throughput of which can be varied by way of a control valve 19. For example, the quantity of a supplied heating vapor or of a coolant can be varied, as a result of which the amount of heat which can be transferred to the fluid or extracted from the fluid can be adjusted.

Once the fluid has been directed through the air preparation device 11, said fluid is supplied to a material preparation device 12 which in the exemplary embodiment illustrated is configured as a drum dryer. The treatment of the respective material within the material preparation device 12 takes place with the fluid, preferably according to the counterflow principle. Besides the fluid mass fed by way of the air preparation device 11 and the main line 21, a further fluid flow is directed to the material preparation device 12. The further fluid flow, which in the exemplary embodiment illustrated is not subjected to any further treatment, is directed to the material preparation device 12 by way of a separate branch line 14 in the region of the inlet of the main line 21.

The branch line 14 branches off from the main line 21 directly after the inlet 2, prior to any further fluid treatment taking place. A second fan 13, which is operated by way of a controlled motor as the drive 16, is disposed within the branch line 14. The fluid, which has been pre-treated by the air preparation apparatuses 10, by way of the branch line 14 is directed to the material preparation device 12 in a separate inlet and therein mixed with the other fluid flow from the main line 21. Cold air is in particular supplied to the material preparation device 12 by way of the branch line 14. The branch line 14 can also be closed, such that the fluid is directed into the material preparation device 12 only by way of the main line 21. In principle, it is also possible that the air preparation device 11 is used for cooling the fluid or the air. The quality of the fluid for the material preparation device 12 can be adjusted by the different treatment of the fluid in the main line 21 and the branch line 14. The quality of the fluid is adjusted by feedback-controlling or controlling the drives 4, 16 of the fans 3, 13 in a corresponding manner.

The envisaged treatment of the material takes place within the material preparation device 12, the material being, for example, cooled, dried, singularized or heated. As has already been discussed above, the preparation of the material preferably takes place by counterflow, i.e. that the prepared material exits the material preparation device 12 in the region of the inlet of the fluid, and the supply of material takes place at the exit end for the fluid. Neither the inlet nor the outlet for the material to be processed or prepared is illustrated. An air outlet 15, or a fluid outlet 15, by way of which the fluid exits is configured at the end of the material preparation device 12. A pressure loss takes place between the inlet of the material preparation device 12 and the air outlet 15, so that this region can be referred to as the pressure loss portion 6. From the air outlet 15, the fluid by way of a further driven fan 23 is suctioned through a cleaning device 20, for example through a cyclone separator, a filter device, a further heat exchanger, or the like. Proceeding from the cleaning device 20, the process air or the process fluid either escapes into the environment or is fed to further handling or use.

Two pressure sensors 7, 8 are disposed within the pipeline of the system 1; the first sensor 7 is situated within the main line 21 which is rooted from the inlet 2 through the air preparation device 11 into the material preparation device 12. The first sensor 7 in the flow direction is disposed behind the air preparation apparatuses 10 after the inlet 2 and ahead of the fan 3. The second sensor 8 in the outlet line is disposed after the air outlet 15 and ahead of the outlet 5 into the cleaning device 20. In a variant, the first sensor 7 in the flow direction is disposed ahead of the branch line 14 after the inlet 2, as a result of which the pressure drop across the entire system 1, from the inlet 2 to the outlet 5, can be better detected. The first measuring location for the first pressure sensor 7 is thus situated after the air preparation apparatuses 10, but ahead of a potential branch line 14 and ahead of the fans 3, 13. The second measuring location having the second pressure sensor 8 is advantageously installed directly at the air outlet 15 such that a further pressure drop within the pipeline, after the exit from the material preparation device 12, is not taken into account when detecting the pressure drop. As a result, the pressure drop across the entire system 1, i.e. the single pressure drop important for controlling the fans 3, 13, is detected with the greatest accuracy.

Both sensors 7, 8 are in each case connected to a calculation module 9a, 9b, within which a calculation of the respective air mass or fluid mass to be supplied by way of the values obtained by the sensors 7, 8 takes place. The output variable of the calculation modules 9a, 9b to the respective assigned control device 22a, 22b, the latter preferably being configured as PID controllers, is the currently calculated fluid mass.

If only one fluid flow has to be controlled by way of the fan 3, only one controller 22b is required; if more than two fans 3, 13 are present, for example so as to mix more than two different fluid qualities, a corresponding number of controllers 22a, 22b are provided. Based on the sensor values of the sensors 7, 8 as input signals, the values for the flow of cold air and the flow of warm air are calculated within the calculation module 9a, 9b and transmitted as actual value to the control device 22a, 22b. The control device 22a, 22b compares the actual value with the required setpoint value and transmits the output of the control device 22a, 22b to the frequency inverter of the respective drives 4, 16. In the case of frequency-controlled drives, the values, being actuating values, are the frequencies of the electric current for the respective drive motor 4, 16. The drives 4, 16 of the fans 3, 13 are separately controlled by way of this control, so that different amounts of cold air and warm air are supplied to the material preparation device 12. The volumetric flow control circuits shown can emit a switching signal or an alarm signal when a limit rotating speed for the respective drive 4, 16 is reached, so that filters can be replaced or the material quantity of the material to be treated is varied, for example. The required air mass or fluid mass depends on the quantity of the product to be processed.

A signal flow chart for controlling a fan 3 is shown in FIG. 2, in the exemplary embodiment illustrated for the fan in the main line 21. Controlling of the second fan 13 in the branch line 14 takes place in an analogous manner. The sensor value X1 of the first sensor 7 for the pressure in the system 1 directly after the inlet 2, and the sensor value X2 of the second sensor 8 just before the outlet 5 of the system 1, more specifically just after the air outlet 15 from the material preparation device 12, are combined so as to form a common pressure value Y1, whereby an additional value Y6 for the pressure loss is used for calculating the common pressure value Y1, said additional value Y6 being able to be calculated from the adjusted setpoint value of the actuating value transducer 18. The common pressure value Y1 is used for calculating the process value Y5, wherein additional resistances between the fan 13 and the measuring location are added to the common pressure value Y1 by way of the numerical terms Y4 and Y5. The numerical terms Y4 and Y5 are simple polynomials which can be readily integrated into the calculation module. The overall result is the output value Y2 of the volumetric flow control circuit as a variable input signal for the drive 4 of the fan 3. The volumetric flow control circuit in the exemplary embodiment illustrated is configured as a PID controller 22b. the output value Y2 represents the frequency value of the electric current, as the actuating variable, for the frequency-controlled motor of the drive 4. The rotating speed of the motor 4 is varied by varying the frequency; the air throughput of the fan 3 is also varied in this way.

It is possible to determine the currently present air mass or fluid mass running through the drum dryer, or the material preparation device 12, from the pressure sensor values of the sensors 7, 8 in conjunction with the known rotating speed of the fans 3, 13. The air mass or fluid mass is compared with the previously adjusted setpoint value of the volumetric flow control circuit, and in the event of deviations an adaptation is achieved by varying the frequency as the actuating variable. When a limit rotating speed for the respective motor 4 is reached, a warning signal is emitted, an automatic reduction of the material throughput is initiated, or another measure is taken, the system being switched off, for example.

In order for the system 1 to be designed, it is necessary that the operating parameters of the fans 3, 13 are known. A characteristic curve for each fan 3, 13 can be determined by measurements. This characteristic curve shows the correlation between air throughput and generated pressure at a specific rotating speed. In the case of a known rotating speed and a measured pressure difference over the fan, it is possible to determine the air throughput by means of the respective characteristic curve using the correlation between air throughput, generated pressure and rotating speed. Because the fluid mass, or the air mass, which is directed through the material treatment device is typically decisive for the treatment of the material in the system through which fluid flows, the air throughput can be precisely determined by means of the associated characteristic curve, using the known pressure difference and the likewise known rotating speed of the fan. In the case of a change in the rotating speed of the fan, or of the fans, correspondingly deviating characteristic curves are derived, which can either be empirically determined or modified by way of calculating methods using models. In this way, a curve family which is utilized for controlling the fans is calculated from the multiplicity of characteristic curves. In the process, numerical terms are determined for the correlation between pressure difference and air throughput in the rotating speed variation of the fans; these numerical terms are then used in the respective calculation module 9.

Controlling of the fans 3, 13 takes place exclusively based on the measured pressure difference between the two sensors 7, 8; in particular, no air mass measurement or fluid mass measurement within the system 1 is required, as a result of which high costs for necessary modifications can be saved. In the design of the system, no calculations or estimations whatsoever pertaining to the anticipated pressure loss over the pressure loss portion, or within the material preparation device 12, are required; rather, optimized controlling of the drives 4, 16 can be achieved by simple pressure measurements, and the required fluid mass for the material treatment can be provided in an optimal manner.

### LIST OF REFERENCE SIGNS

1—System
2—Inlet
3—Fan
4—Drive
5—Outlet
6—Pressure loss portion
7—Sensor
8—Sensor
9a, 9b—Calculation module
10—Air preparation apparatus
11—Air preparation device
12—Material preparation device
13—Fan
14—Branch line
15—Air outlet
16—Drive
19—Valve
20—Cleaning device
21—Main line
22a, 22b—Control device
23—Fan

1. A method for controlling a conveyed mass flow of fluid or air in a system through which fluid or air flows,
wherein the system comprises:
an inlet,
at least one fan which in a flow direction is disposed downstream of the inlet, wherein the at least one fan comprises a drive;
an outlet for fluid or air conveyed by the at least one fan;
a pressure loss portion between the at least one fan and the outlet,
at least one sensor coupled to at least one calculation module and at least one control device,
wherein the drive of the at least one fan is controlled based on sensor values,
a first pressure sensor in the flow direction is disposed ahead of the at least one fan, and
a second pressure sensor in the flow direction is disposed after the pressure loss portion,
and
wherein in the method the at least one fan in terms of rotating speed is controlled based on a measured pressure difference between the first pressure sensor and the second pressure sensor.

2. The method according to claim 1, further comprising preparing the fluid or the air by at least one fluid or air preparation apparatus ahead of the first pressure sensor.

3. The method according to claim 1, further comprising preparing the fluid or the air by at least one fluid or air preparation device after the at least one fan.

4. The method according to claim 1 wherein the at least one fan in the system comprises a plurality of fans, and wherein the method further comprising
preparing differently prepared fluid or differently prepared air from the a plurality of fans; and
suppling the differently prepared fluid or the differently prepared air to the pressure loss portion.

5. The method according to claim 1 further comprising directing the fluid or the air in the pressure loss portion of the system through a material preparation device.

6. The method according to claim 1 further comprising determining a rotating speed of the drive required for adapting a mass of fluid or air from a curve family which stored in the at least one calculation module.

7. A system through which fluid or air flows, comprising:
an inlet;
at least one fan which in a flow direction is disposed downstream of the inlet, wherein the at least one fan has a drive;
an outlet for fluid or air conveyed by the at least one fan;
a pressure loss portion between the at least one fan and the outlet;
at least one sensor coupled to at least one calculation module and at least one control device, wherein the drive of the at least one fan is controlled based on sensor values;
a first pressure sensor in the flow direction is disposed ahead of the at least one fan; and
a second pressure sensor in the flow direction is disposed after the pressure loss portion, wherein the first pressure sensor and the second pressure sensor are coupled to the control device, and wherein the control device controls the drive by changing a rotating speed of the at least one fan based on a pressure difference calculated from measured pressure sensor values of the first pressure sensor and the second pressure sensor.

8. The system of claim 7, further comprising at least one fluid or air preparation apparatus in the flow direction is disposed ahead of the first pressure sensor.

9. The system of claim 7, further comprising at least one fluid or air preparation device in the flow direction is disposed after the at least one fan.

10. The system of claim 7, further comprising a branch line leading to a second fan which conveys fluid or air into the pressure loss section, wherein the branch line is in the flow direction after the first pressure sensor.

11. The system of claim 7 further comprising a material preparation device which has a material supply port disposed in the pressure loss portion (6).

12. The system of claim 7 wherein the second pressure sensor is positioned directly at the end of the pressure loss portion.

13. The system of claim 11 wherein the material preparation device is a dryer.
